(19) United States
(12) Patent Application Publication
(10) Pub. No.: US 2025/0360404 A1
(43) Pub. Date: Nov. 27, 2025

(54) NON-TRANSITORY COMPUTER-READABLE STORAGE MEDIUM HAVING GAME PROGRAM STORED THEREIN, GAME PROCESSING METHOD, AND SYSTEM

(71) Applicant: NINTENDO CO., LTD., Kyoto-shi (JP)

(72) Inventors: Hiroki HAMAUE, Kyoto (JP); Yoshinori KONISHI, Kyoto (JP); Taro NONAKA, Kyoto (JP)

(21) Appl. No.: 19/287,095

(22) Filed: Jul. 31, 2025

Related U.S. Application Data
(63) Continuation of application No. PCT/JP2023/041340, filed on Nov. 16, 2023.

(51) Int. Cl. A63F 13/42; A63F 13/285; A63F 13/56; A63F 13/812

(52) U.S. Cl. CPC A63F 13/42; A63F 13/285; A63F 13/56; A63F 13/812

(57) ABSTRACT

When a first mouse and a second mouse are both moved in a first direction, a first virtual object is caused to move forward in a virtual space, and when the first mouse and the second mouse are both moved in a direction opposite to the first direction, the first virtual object is caused to move backward. The first virtual object is turned left or right based on the difference between a movement amount of the first mouse indicated by first data and a movement amount of the second mouse indicated by second data.

### CROSS REFERENCE TO RELATED APPLICATION

This application is a continuation of International Patent Application No. PCT/JP2023/041340 filed on Nov. 16, 2023, the entire contents of which is incorporated herein by reference.

### FIELD

The present disclosure relates to information processing.

### BACKGROUND AND SUMMARY

Conventionally, games for which a mouse is used as an operation device are known.

For example, the following configuration examples are exemplified.

One configuration example is directed to a non-transitory computer-readable storage medium having stored therein a game program including instructions that, when executed, cause a computer to perform operations including: acquiring first data regarding movement, on a work surface, of a first mouse operated by one hand of a user; acquiring second data regarding movement, on a work surface that is the same as or different from the work surface, of a second mouse operated by another hand of the user; causing a first virtual object to move forward in a virtual space when the acquired first data and second data respectively indicate that the first mouse and the second mouse have been moved in a first direction; causing the first virtual object to move backward when the acquired first data and second data respectively indicate that the first mouse and the second mouse have been moved in a direction opposite to the first direction; and causing the first virtual object to turn left or right, based on a difference between a movement amount of the first mouse indicated by the first data and a movement amount of the second mouse indicated by the second data.

In another configuration example, the operations may further include: determining a first parameter increasing as the movement amount of the first mouse increases, based on the first data; determining a second parameter increasing as the movement amount of the second mouse increases, based on the second data; and adjusting at least one of values of the first parameter and the second parameter such that a difference between the first parameter and the second parameter decreases.

According to the above configuration examples, it is possible to assist the user in performing an operation for causing the first virtual object to move straight.

In another configuration example, the adjusting may be adjustment in which, of the first parameter and the second parameter, the value of the parameter that is smaller is brought closer to the value of the parameter that is larger.

According to the above configuration example, since the value of the parameter that is smaller can be brought closer to the value of the parameter that is larger and for which the user's intention to move the first virtual object a large distance is inferred, it is possible to move the first virtual object by a movement amount corresponding to the user's intention.

In another configuration example, the operations may further include performing the adjusting when a movement speed of the first mouse indicated by the first data and a movement speed of the second mouse indicated by the second data are both higher than a predetermined value.

According to the above configuration example, it is possible to improve straight movability by reflecting the user's intention to move straight.

In another configuration example, the operations may further include: decreasing the first parameter in accordance with passage of time; decreasing the second parameter in accordance with passage of time; and decreasing the first parameter and the second parameter such that the difference between the first parameter and the second parameter decreases.

According to the above configuration example, it is possible to perform movement control that is influenced by resistance such as frictional resistance.

In another configuration example, the operations may further include: placing the first virtual object on a ground object in the virtual space; and applying an influence corresponding to a state of the ground object at a position at which the first virtual object is placed, to the first parameter and the second parameter.

According to the above configuration example, it is possible to perform movement control that is influenced by the gradient of the ground.

In another configuration example, the operations may further include: acquiring third data outputted in response to a first operation on the first mouse by the user; acquiring fourth data outputted in response to the first operation on the second mouse by the user; decreasing the first parameter, based on the acquired third data; and decreasing the second parameter, based on the acquired fourth data.

According to the above configuration example, it is possible to perform brake control corresponding to a brake operation.

In another configuration example, the operations may further include causing the first virtual object to perform a shooting action of causing a second virtual object to fly from the first virtual object in the virtual space, based on fifth data, acquired from at least one of the first mouse and the second mouse, indicating an operation of raising the mouse and then shaking the mouse.

According to the above configuration example, when causing the first virtual object to perform a shooting action by performing an operation of raising the mouse and then shaking the mouse, an operation for moving the first virtual object cannot be performed by performing an operation of moving the mouse on the work surface, so that the entertainment characteristics of operation can be improved.

In another configuration example, the operations may further include: causing the second virtual object to fly toward a goal, in response to the shooting action, regardless of orientation of the first virtual object; and determining a probability of success of a shot by the shooting action, based on orientation of the first virtual object with respect to the goal at a time of the shooting action.

According to the above configuration example, even if, by performing a shooting action, the mouse used for performing the shooting action cannot be used for movement operations and then the orientation of the first virtual object changes, the second virtual object flies toward the goal, so that it is possible to avoid an excessive increase in the difficulty level of the operation for shooting. Meanwhile, since the probability of success of a shot is determined based on the orientation of the first virtual object, when performing a shooting operation, it becomes necessary to perform an operation for causing the first virtual object to face in a direction that is as close to the goal as possible, so that the entertainment characteristics of operation are improved.

In another configuration example, the first virtual object may be a wheelchair object, and the operations may further include vibrating at least one of the first mouse and the second mouse, based on at least one of the first data and the second data.

According to the above configuration example, it is possible to provide a sense of operating the wheelchair object by performing an operation of moving the two mice on the work surfaces.

In another configuration example, the first mouse may have a plate shape in which a side surface extending in a longitudinal direction of the plate shape is a bottom surface facing the work surface when the first mouse is operated to be moved on the work surface, and the second mouse may have a plate shape in which a side surface extending in a longitudinal direction of the plate shape is a bottom surface facing the work surface when the second mouse is operated to be moved on the work surface.

According to the above configuration example, it becomes easier for the user to hold the mice and operate the mice to move on the work surfaces.

According to the exemplary embodiments, it is possible to provide, for example, a game processing method, etc., that realize a novel game as a game for which mice are used as operation devices.

### BRIEF DESCRIPTION OF THE DRAWINGS

FIG. 1 is a block diagram showing a non-limiting example of the internal configuration of a game apparatus 10;

FIG. 2 is a schematic diagram showing a non-limiting example of the appearance of a left mouse and a right mouse;

FIG. 3 illustrates an operation method for the left mouse and the right mouse;

FIG. 4 illustrates an operation method for a game;

FIG. 5 illustrates the operation method for the game;

FIG. 6 illustrates the operation method for the game;

FIG. 7 illustrates the operation method for the game;

FIG. 8 illustrates the operation method for the game;

FIG. 9 illustrates adjustment of a left velocity parameter and a right velocity parameter;

FIG. 10 illustrates the adjustment of the left velocity parameter and the right velocity parameter;

FIG. 11 illustrates the LVP and the RVP during brake operation;

FIG. 12 illustrates the operation method for the game;

FIG. 13 illustrates the operation method for the game;

FIG. 14 shows a non-limiting example of various data stored in a storage unit 12;

FIG. 15 is a non-limiting example of a flowchart of game processing;

FIG. 16 is a non-limiting example of a flowchart of the game processing;

FIG. 17 is a non-limiting example of a flowchart of the game processing; and

FIG. 18 is a non-limiting example of a flowchart of the game processing.

### DETAILED DESCRIPTION OF NON-LIMITING EXAMPLE EMBODIMENTS

Hereinafter, an exemplary embodiment will be described.

### [Hardware Configuration of Information Processing Apparatus]

An information processing apparatus (information processing system) for executing information processing according to the exemplary embodiment will be described. The information processing apparatus is, for example, a stationary or hand-held game apparatus, a personal computer, a tablet terminal, a smartphone, a wearable terminal, or the like. The information processing apparatus according to the exemplary embodiment may be a server or may be composed of a game apparatus or the like as described above and a predetermined server. In the exemplary embodiment, a description will be given with a stationary game apparatus (sometimes referred to simply as “game apparatus”) as an example of the information processing apparatus.

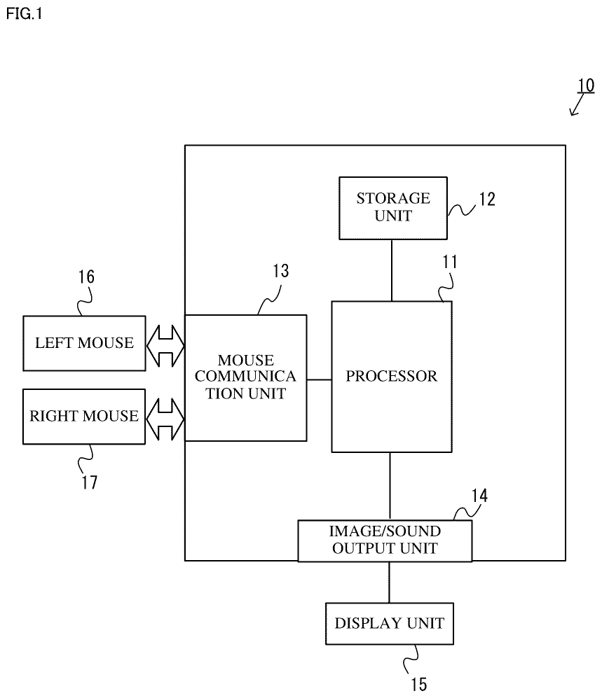

FIG. 1 is a block diagram showing an example of the internal configuration of a game apparatus (game system) 10 according to the exemplary embodiment. The game apparatus 10 includes a processor 11. The processor 11 is an information processing unit that executes various types of information processing to be executed in the game apparatus 10, and may, for example, be composed of only a CPU (Central Processing Unit) or be composed of a SoC (System-on-a-Chip) including a plurality of functions such as a CPU function and a GPU (Graphics Processing Unit) function. The processor 11 executes various types of information processing by executing an information processing program (e.g., a game program) stored in a storage unit 12. The storage unit 12 may be, for example, an internal storage medium such as a flash memory or a DRAM (Dynamic Random Access Memory) or may be configured to utilize an external storage medium mounted to a slot that is not shown, or the like.

The game apparatus 10 also includes a mouse communication unit 13 for performing wired communication or wireless communication with a left mouse 16 and a right mouse 17.

In addition, a display unit 15 (e.g., a television or the like) is connected to the game apparatus 10 via an image/sound output unit 14. The processor 11 outputs images and sounds generated (e.g., by executing the above information processing) to the display unit 15 capable of outputting sounds, via the image/sound output unit 14.

The game apparatus 10 also includes a network communication unit (not shown) and can communicate with external devices via a network. The network communication unit connects to a wireless LAN using a method compliant with, for example, the Wi-Fi standard, and performs Internet communication, etc., with external devices (other game apparatuses 10). In addition, the network communication unit can perform short-range wireless communication (e.g., infrared communication) with other game apparatuses 10.

The left mouse 16, the right mouse 17, and the display unit 15 may be considered to be included in the game apparatus 10 or may be considered to not be included in the game device 10.

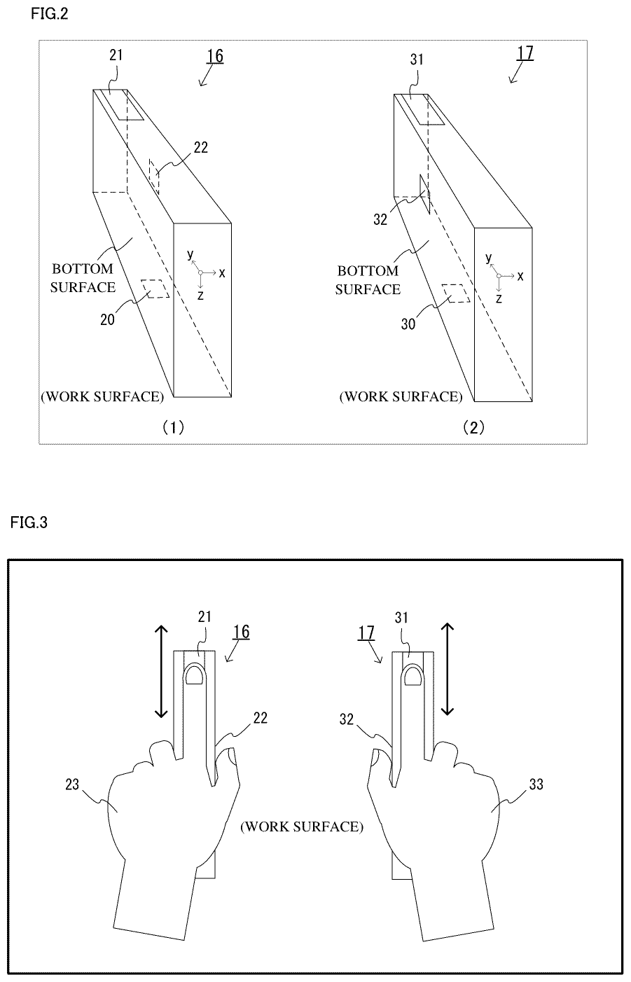

FIG. 2 is a schematic diagram showing an example of the appearance of the left mouse 16 and the right mouse 17. As shown in FIGS. 2(1) and (2), the left mouse 16 and the right mouse 17 each have a plate shape with a y-axis direction as a longitudinal direction (a rectangular parallelepiped shape in which the thickness in an x-axis direction is smaller than the thickness in a z-axis direction and the thickness in the z-axis direction is smaller than the thickness in the y-axis direction, or a shape similar thereto) and have the same size.

The left mouse 16 and the right mouse 17 each include an inertial sensor. Specifically, the left mouse 16 and the right mouse 17 each include an acceleration sensor (not shown) and an angular velocity sensor (not shown). The acceleration sensor detects the magnitudes of accelerations along three predetermined axes (x, y, and z axes shown in FIGS. 2(1) and (2)). The acceleration sensor may detect an acceleration in one axial direction or accelerations in two axial directions. The angular velocity sensor detects angular velocities around three predetermined axes (x, y, and z axes shown in FIGS. 2(1) and (2)). The angular velocity sensor may detect an angular velocity around one axis or angular velocities around two axes. The detection results of the acceleration sensor and the angular velocity sensor are repeatedly transmitted to the mouse communication unit 13 at appropriate timings.

As shown in FIG. 2(1), the left mouse 16 includes a sensor (sometimes referred to as “mouse sensor”) 20 that detects operations such as a user (player) sliding the left mouse 16 on a work surface (a work surface with which a bottom surface shown in FIG. 2(1) is in contact), on the bottom surface thereof. The mouse sensor 20 is, for example, a typical mouse sensor (e.g., an optical or laser sensor) that acquires data for calculating the movement (movement direction, movement distance, movement speed, etc.), on the work surface, of the left mouse 16 positioned such that the bottom surface thereof faces the work surface. As shown in FIG. 2(1), the left mouse 16 also includes a button 21 and a button 22. Data indicating the operation states of the button 21 and the button 22 is repeatedly transmitted to the mouse communication unit 13 at appropriate timings.

As shown in FIG. 2(2), the right mouse 17 also includes a sensor 30 that detects operations such as the user sliding the right mouse 17 on a work surface (a work surface with which a bottom surface shown in FIG. 2(2) is in contact), on the bottom surface thereof. The mouse sensor 30 is the same type of sensor as the mouse sensor 20. Data acquired by the mouse sensor 20 of the left mouse 16 and data acquired by the mouse sensor 30 of the right mouse 17 are repeatedly transmitted to the mouse communication unit 13 at appropriate timings. As shown in FIG. 2(2), the right mouse 17 also includes a button 31 and a button 32. Data indicating the operation states of the button 31 and the button 32 is repeatedly transmitted to the mouse communication unit 13 at appropriate timings.

In addition, the left mouse 16 is provided with a vibration device (not shown) that vibrates the left mouse 16, and the right mouse 17 is provided with a vibration device (not shown) that vibrates the right mouse 17.

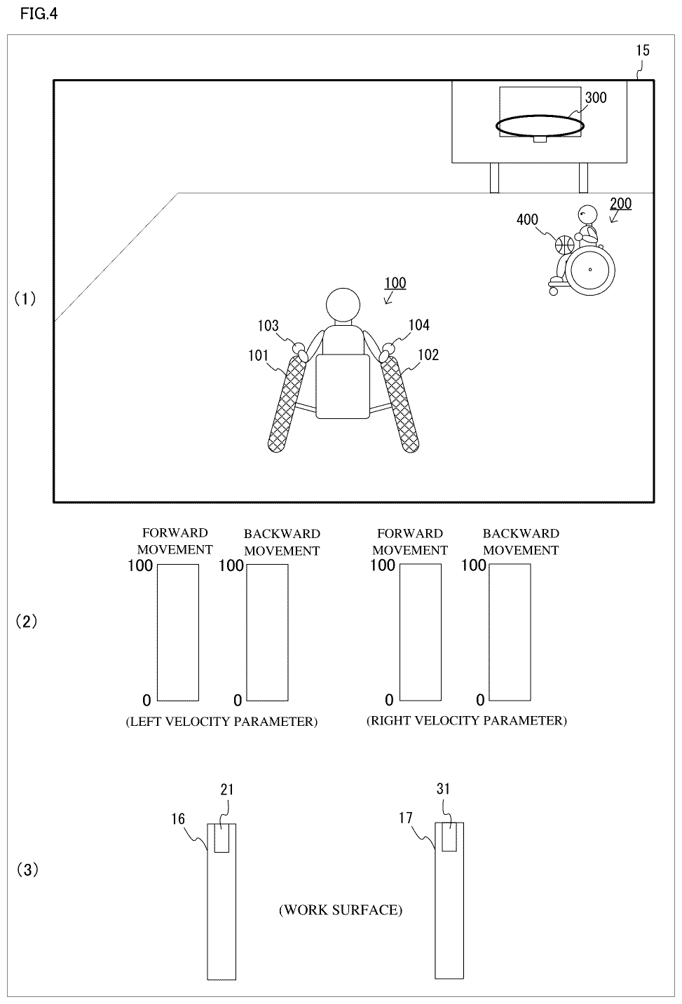

FIG. 3 illustrates an operation method for the left mouse 16 and the right mouse 17. As shown in FIG. 3, the user holds the left mouse 16 with a left hand 23 and holds the right mouse 17 with the right hand 33. Then, as shown in FIG. 3, the user can perform an operation of moving the left mouse 16 in the front-rear direction (y-axis direction in FIG. 2(1)) on the work surface, can press the button 21 with the index finger or the middle finger, and can press the button 22 with the thumb. In addition, as shown in FIG. 3, the user can perform an operation of moving the right mouse 17 on the work surface in the front-rear direction (y-axis direction in FIG. 2(2)), can press the button 31 with the index finger or the middle finger, and can press the button 32 with the thumb.

The work surface for the left mouse 16 and the work surface for the right mouse 17 may be different work surfaces rather than a single work surface (common work surface). For example, the user can use the upper surface (front surface) of the left thigh as the work surface for the left mouse 16 and can use the upper surface (front surface) of the right thigh as the work surface for the right mouse 17.

### [Game Assumed in Exemplary Embodiment]

Next, the outline of game processing executed by the game apparatus 10 according to the exemplary embodiment will be described. A game assumed in the exemplary embodiment is, as an example, a wheelchair basketball game played by three players (users) against three players (users). Specifically, player objects (objects each representing a wheelchair with a person riding thereon, sometimes referred to as “PO”) move, etc., within a virtual space (game space), in which a court and a goal of the wheelchair basketball game are arranged, in response to operations of the respective players, to play the wheelchair basketball game. Some of the objects each representing a wheelchair with a person riding thereon may be non-player objects controlled automatically. In addition, this game may be a game in which one object representing a wheelchair with a person riding thereon appears. Moreover, this game is not limited to the wheelchair basketball game and may be another type of game.

### [Outline of Game Processing of Exemplary Embodiment]

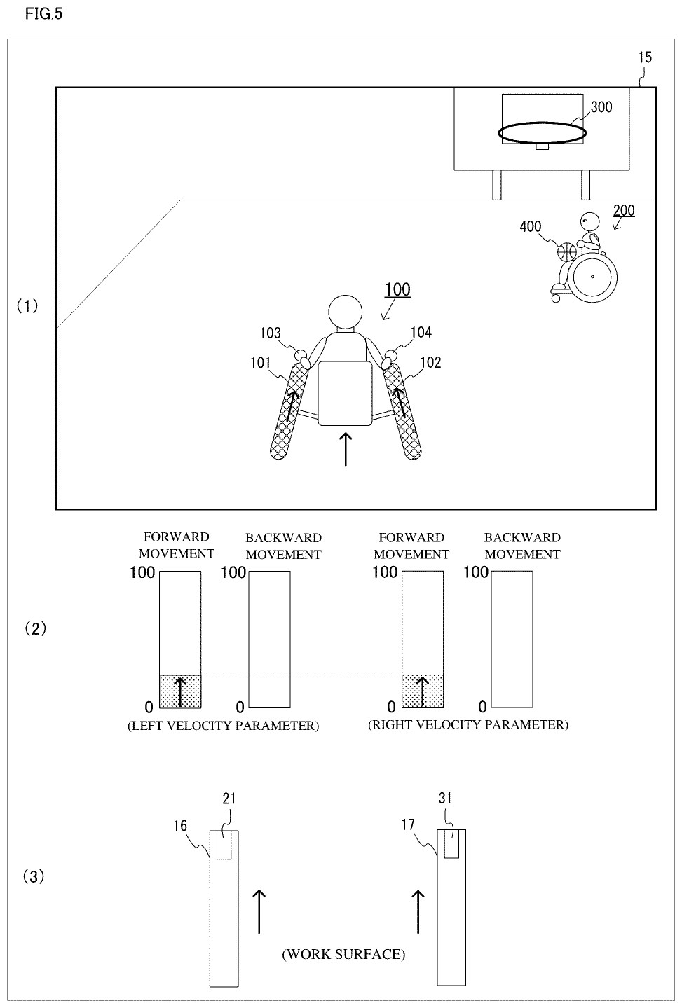

Next, the outline of operation of the game processing executed by the game apparatus 10 according to the exemplary embodiment will be described. FIG. 4 illustrates an operation method for a PO in this game. FIG. 4(1) is an example of a game image obtained by rendering the virtual space of this game. In FIG. 4(1), a PO 100 operated by the player of the game apparatus 10, a PO 200 operated by the player of another game apparatus 10, and a goal 300 are displayed. When a PO moves while holding the ball 400, the PO moves with the ball 400 placed on the knees thereof as an example.

FIG. 4(2) is a conceptual diagram (graph) showing the values of velocity parameters (sometimes referred to as “VPs”) used to move the POs within the virtual space. The VPs may be included in the game image or may not necessarily be included in the game image. As shown in FIG. 4(2), the VPs include a left velocity parameter (sometimes referred to as “LVP”) and a right velocity parameter (sometimes referred to as “RVP”). The LVP and the RVP each have “forward movement” and “backward movement” for which values can vary from 0 to 100. The LVP indicates the movement speed and the movement direction of the PO 100 on a left wheel 101 side (i.e., the left side). The RVP indicates the movement speed and the movement direction of the PO 100 on a right wheel 102 side (i.e., the right side).

The value of the LVP is incremented in accordance with the movement speed of the left mouse 16 in the front-rear direction (y-axis direction in FIG. 2(1)) on the work surface calculated from data acquired by the mouse sensor 20. The value of the RVP is incremented in accordance with the movement speed of the right mouse 17 in the front-rear direction (y-axis direction in FIG. 2(2)) on the work surface calculated from data acquired by the mouse sensor 30. For example, the average value of a predetermined number of most recent movement amounts (e.g., five most recent movement amounts) of the mouse per rendering frame (processing frame) in the front-rear direction on the work surface (hereinafter sometimes referred to as “movement speed”) is calculated, and a value obtained by multiplying the calculated average value by a predetermined coefficient (e.g., 2) is added to the VP. This addition based on the movement speed of each mouse is sometimes referred to as “mouse operation addition”. Additionally, as described later, on the values of the LVP and the RVP, further, addition or subtraction (sometimes referred to as “gradient addition” or “gradient subtraction”) is performed in accordance with the gradient (inclination) of the ground on which the PO 100 is located, subtraction (sometimes referred to as “resistance subtraction”) is performed in order to achieve deceleration of the PO 100 due to resistance such as frictional resistance or air resistance, and subtraction (sometimes referred to as “brake subtraction”) is performed in response to a brake operation by the player. The movement direction (including a turning direction) or the movement speed of the PO 100 is determined based on whether each of the LVP and the RVP represents forward movement or backward movement and the extent of such movement. In the following example, for simplicity, the gradient addition, the gradient subtraction, the resistance subtraction, and the brake subtraction are not performed unless otherwise specified. As described later, the values of the VPs may be adjusted.

Specifically, as described later, this allows the player to operate the PO 100 to move as if moving a real wheelchair by moving the left and right wheels with the left and right hands, by performing an operation of moving the left mouse 16 on the work surface (sometimes referred to as “left mouse movement operation”) with the left hand and performing an operation of moving the right mouse 17 on the work surface (sometimes referred to as “right mouse movement operation”) with the right hand. The left mouse movement operation and the right mouse movement operation are sometimes collectively referred to as “mouse movement operation”.

FIG. 4(3) shows the operation states of the left mouse 16 and the right mouse 17. As shown in FIG. 4(3), the left mouse 16 and the right mouse 17 are in states where no movement operation on the work surface is performed, and no mouse operation addition is performed. In this state, as shown in FIG. 4(2), the values of the VPs are all 0 (zero), and as shown in FIG. 4(1), the PO 100 is in a state where neither movement nor rotation at the same position is made.

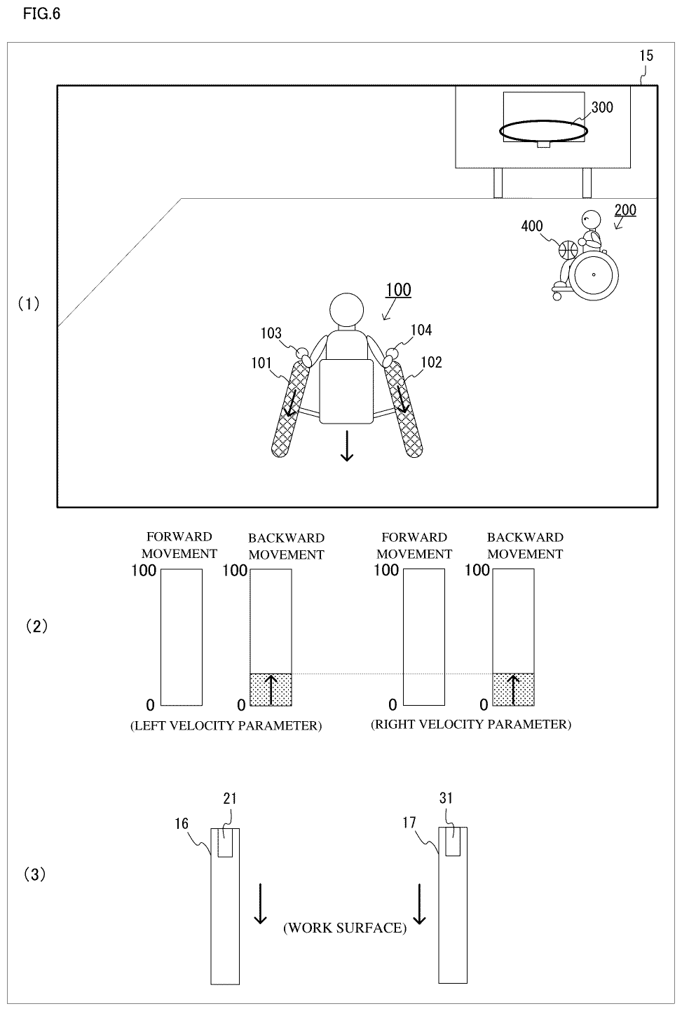

FIG. 5 illustrates an operation for causing the PO 100 to start moving straight forward. The following case is considered: from a state where the LVP and the RVP are 0 (zero) and the PO 100 is stationary, simultaneously with the left mouse movement operation being performed in the forward direction (y-axis positive direction in FIG. 2(1)), the right mouse movement operation is performed in the forward direction (y-axis positive direction in FIG. 2(2)) at the same movement speed as the left mouse movement operation as shown in FIG. 5(3). In this case, as shown in FIG. 5(2), the value of “forward movement” of the LVP and the value of “forward movement” of the RVP are increased from 0 to the same value. Then, as shown in FIG. 5(1), the left wheel 101 side (left side) of the PO 100 moves forward at a speed corresponding to the value of “forward movement” of the LVP, and simultaneously, the right wheel 102 side (right side) of the PO 100 moves forward at a speed corresponding to the value of “forward movement” of the RVP. As a result, the PO 100 starts moving straight forward as shown in FIG. 5(1).

FIG. 6 illustrates an operation for causing the PO 100 to start moving straight backward. The following case is considered: from a state where the LVP and the RVP are 0 (zero) and the PO 100 is stationary, simultaneously with the left mouse movement operation being performed in the backward direction, the right mouse movement operation is performed in the backward direction at the same movement speed as the left mouse movement operation as shown in FIG. 6(3). In this case, as shown in FIG. 6(2), the value of “backward movement” of the LVP and the value of “backward movement” of the RVP are increased from 0 to the same value. Then, as shown in FIG. 6(1), the left wheel 101 side (left side) moves backward at a speed corresponding to the value of “backward movement” of the LVP, and the right wheel 102 side (right side) moves backward at a speed corresponding to the value of “backward movement” of the RVP. As a result, the PO 100 starts moving straight backward as shown in FIG. 6(1).

In the above, the operation for starting straight forward or straight backward movement from a stationary state has been described. If the LVP and the RVP are increased to the same value as a result of the mouse movement operation performed during forward or backward movement, the PO 100 accelerates straight. For example, when, simultaneously with the left mouse movement operation being performed in the forward direction, the right mouse movement operation is performed in the forward direction at a movement speed different from that of the left mouse movement operation, if the LVP and the RVP are increased to the same value, the PO 100 accelerates while moving straight forward. The same applies to the case of moving backward. In addition, if the LVP and the RVP are decreased to the same value as a result of the mouse movement operation performed during forward or backward movement, the PO 100 decelerates while moving straight. Similarly, if the LVP and the RVP are maintained at the same value as a result of the mouse movement operation performed during forward or backward movement, the PO 100 maintains straight movement.

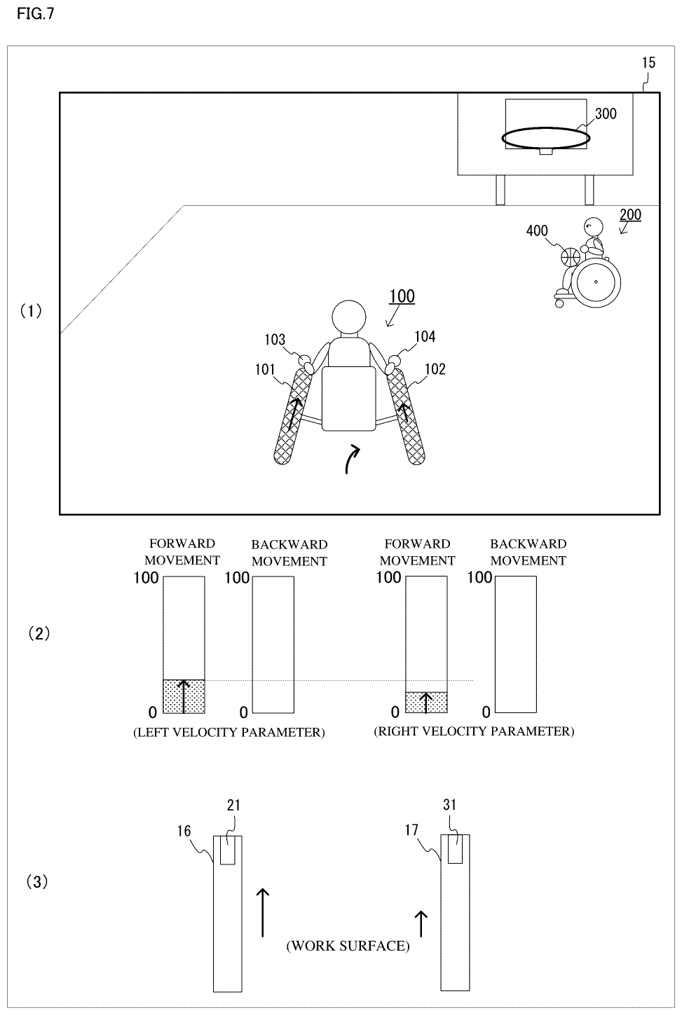

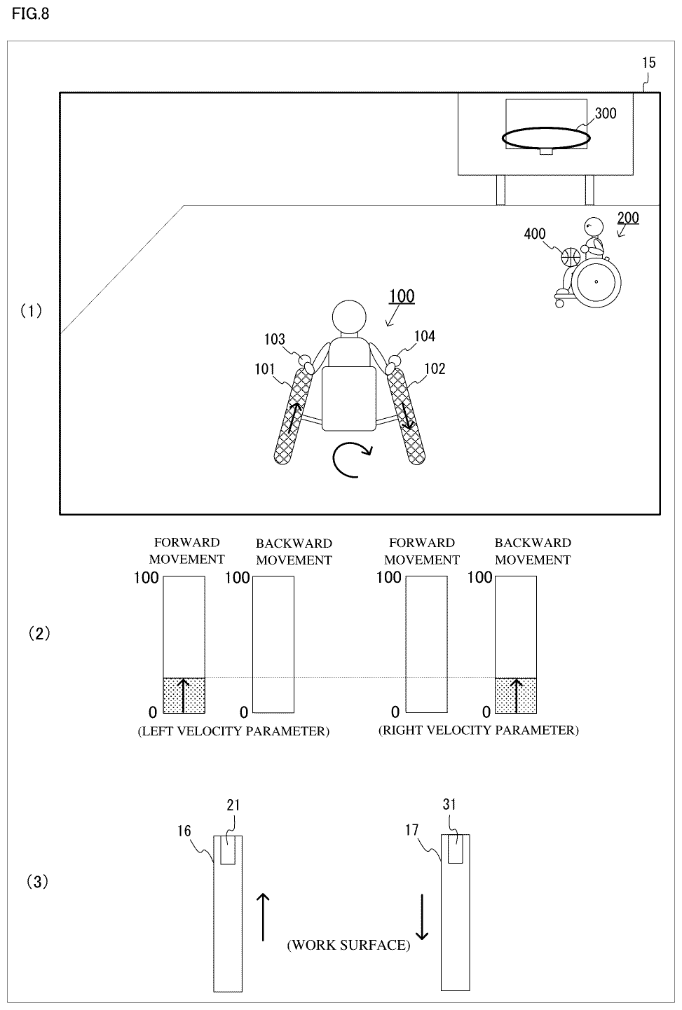

FIG. 7 illustrates an operation for causing the PO 100 to start moving forward while making a turn (turning). The following case is considered: from a state where the LVP and the RVP are 0 (zero) and the PO 100 is stationary, simultaneously with the left mouse movement operation being performed in the forward direction, the right mouse movement operation is performed in the forward direction at a movement speed lower than that of the left mouse movement operation as shown in FIG. 7(3). In this case, as shown in FIG. 7(2), the value of “forward movement” of the LVP is increased from 0, and the value of “forward movement” of the RVP is increased to a value smaller than the value of “forward movement” of the LVP. Then, as shown in FIG. 7(1), the left wheel 101 side (left side) of the PO 100 moves forward at a speed corresponding to the value of “forward movement” of the LVP, and simultaneously, the right wheel 102 side (right side) of the PO 100 moves forward at a speed corresponding to the value of “forward movement” of the RVP. As a result, the PO 100 moves forward while making a right turn (turning right) as shown in FIG. 7(1).

The same applies to the case where the PO 100 starts moving backward while making a right turn (not shown). The following case is considered: from a state where the LVP and the RVP are 0 (zero) and the PO 100 is stationary, simultaneously with the left mouse movement operation being performed in the backward direction, the right mouse movement operation is performed in the backward direction at a movement speed lower than that of the left mouse movement operation. In this case, the value of “backward movement” of the LVP is increased from 0, and the value of “backward movement” of the RVP is increased to a value smaller than the value of “backward movement” of the LVP. Then, the left wheel 101 side (left side) of the PO 100 moves backward at a speed corresponding to the value of “backward movement” of the LVP, and simultaneously, the right wheel 102 side (right side) of the PO 100 moves backward at a speed corresponding to the value of “backward movement” of the RVP. As a result, the PO 100 moves backward while making a right turn (turning left). Both in the case of starting moving forward while making a left turn and in the case of starting moving backward while making a left turn, control is performed with the same mechanism.

In the above, the operation for starting forward or backward movement while making a turn from a stationary state has been described. If the LVP and the RVP are increased to different values as a result of the mouse movement operation performed during forward or backward movement, the PO 100 accelerates while making a turn with a turning extent corresponding to the increased values of the LVP and the RVP (not shown). Similarly, if the LVP and the RVP are decreased to different values as a result of the mouse movement operation performed during forward or backward movement, the PO 100 decelerates while making a turn with a turning extent corresponding to the decreased values of the LVP and the RVP. In addition, similarly, if the LVP and the RVP are maintained at the same value as a result of the mouse movement operation performed during forward or backward movement, the PO 100 maintains the movement while making a turn in the same manner.

Furthermore, in the above, the case of performing the operations of moving the left and right mice on the work surfaces in the same direction (forward direction or backward direction) has been described. However, it is also possible to perform operations of moving the left and right mice in opposite directions on the work surfaces. For example, the following case is considered: as a result of performing the operations of moving the left and right mice in opposite directions, the value of “backward movement” of the LVP becomes 30 and the value of “forward movement” of the RVP becomes 20. In this case, the PO 100 turns left. In this case, whether the PO 100 moves in the forward or backward direction and the speed at which the PO 100 moves may be determined as appropriate by calculations. For example, the PO 100 may move backward while turning at a speed corresponding to 10 which is the difference between the value of “backward movement” of the LVP, 30, and the value of “forward movement” of the RVP, 20. Moreover, for example, if the value of “backward movement” of the LVP is 30 and the values of “forward movement” and “backward movement” of the RVP are 0, the PO 100 may move backward while turning left with the right wheel 102 as a center, that is, rotate counterclockwise with the ground-contact point of the right wheel 102 as a center.

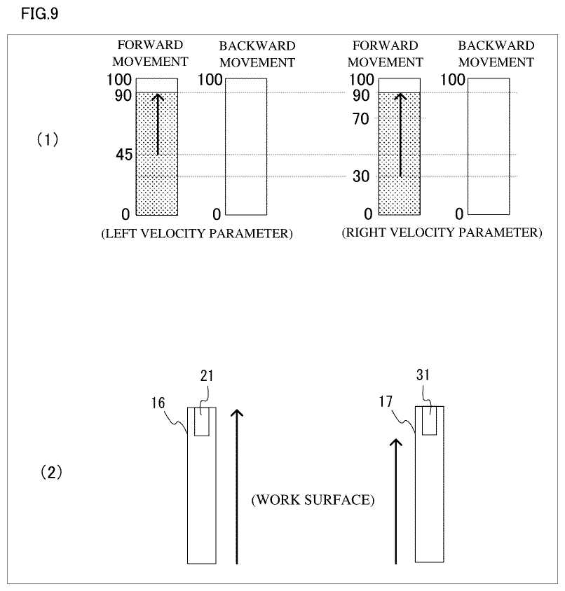

Furthermore, if, as a result of performing the operations of moving the left and right mice in directions opposite to each other on the work surfaces, the value of “forward movement” or “backward movement” of the LVP and the value of “forward movement” or “backward movement” of the RVP become the same, the PO 100 rotates at that place. For example, if the right mouse movement operation is performed in the backward direction simultaneously with the left mouse movement operation being performed in the forward direction (see FIG. 8(3)) and the value of “forward movement” of the LVP and the value of “backward movement” of the RVP become the same (see FIG. 8(2)), the PO 100 rotates (turns) clockwise at that place (see FIG. 8(1)).

FIG. 9 illustrates adjustment of the VPs. In the game processing, if the left and right mouse movement operations are performed in the same direction at a predetermined movement speed (sometimes referred to as “mouse straight movement speed”), adjustment (correction) is performed such that the value of the VP that is smaller is instantly made to be the same as the value of the VP that is larger. The mouse straight movement speed is, for example, a mouse movement speed at which 35 is reached as a result of the mouse operation addition. For example, the following case is considered: when the value of “forward movement” of the LVP is 45 and the value of “forward movement” of the RVP is 30 (see FIG. 9(1)), simultaneously with the left mouse movement operation being performed in the forward direction at a mouse movement speed at which 45 is reached as a result of the mouse operation addition (a mouse movement speed equal to or higher than the mouse straight movement speed), the right mouse movement operation is performed in the forward direction at a mouse movement speed at which 40 is reached as a result of the mouse operation addition (a mouse movement speed equal to or higher than the mouse straight movement speed) (see FIG. 9(2)). In this case, if VP adjustment is not performed, the value of “forward movement” of the RVP becomes 70 which is a value obtained by adding 40 to 30. However, in the exemplary embodiment, VP adjustment is performed in this case, and thus, as shown in FIG. 9(1), adjustment is performed such that the value of the RVP, “70”, which is smaller, is instantly made to be the same as the value of the LVP, “90”, which is larger. As a result, when the player performs the left and right mouse movement operations in the forward direction at relatively high speeds (speeds equal to or higher than the mouse straight movement speed), the PO 100 moves straight forward instantly regardless of the movement speeds of the left and right mice. This enables assisting the player in performing an operation for causing the PO 100 to move straight forward.

In the above, the case where the left and right mouse movement operations are performed in a state where the PO 100 is moving (the VPs are not 0) has been described. However, when the left and right mouse movement operations are performed in a state where the PO 100 is stationary (the VPs are 0), adjustment is similarly performed such that the values of the left and right VPs are made to be the same. This enables assisting the player in performing an operation for causing the PO 100 to move straight forward also when the PO 100 starts moving.

The mouse straight movement speed described above may include a relatively high mouse straight movement speed (sometimes referred to as “first mouse straight movement speed”) and a relatively low mouse straight movement speed (sometimes referred to as “second mouse straight movement speed”). Where a state where the speed of the mouse becomes the first mouse straight movement speed or higher and then falls below the second mouse straight movement speed is referred to as high-speed movement state, when both mice are in such a high-speed movement state, the speeds of both mice may be considered to be equal to or higher the mouse straight movement speed, and the values of the left and right VPs may be made the same.

In the above, the adjustment for causing the PO 100 to move straight forward has been described. The adjustment for causing the PO 100 to move straight backward is also performed in the same manner. This enables assisting the player in performing an operation for causing the PO 100 to move straight backward.

In the above, the adjustment is performed such that the value of the VP that is smaller is instantly made to be the same as the value of the VP that is larger (see FIG. 9(1)). However, in another exemplary embodiment, adjustment may be performed such that the value of the VP that is larger is instantly made to be the same as the value of the VP that is smaller, or adjustment may be performed such that the values of the left and right VPs are made to be the same as the average (intermediate value) of the values of the left and right VPs. Alternatively, adjustment may be performed such that the values of the left and right VPs are gradually made to be the same in accordance with passage of time instead of instantly making the values of the left and right VPs to be the same.

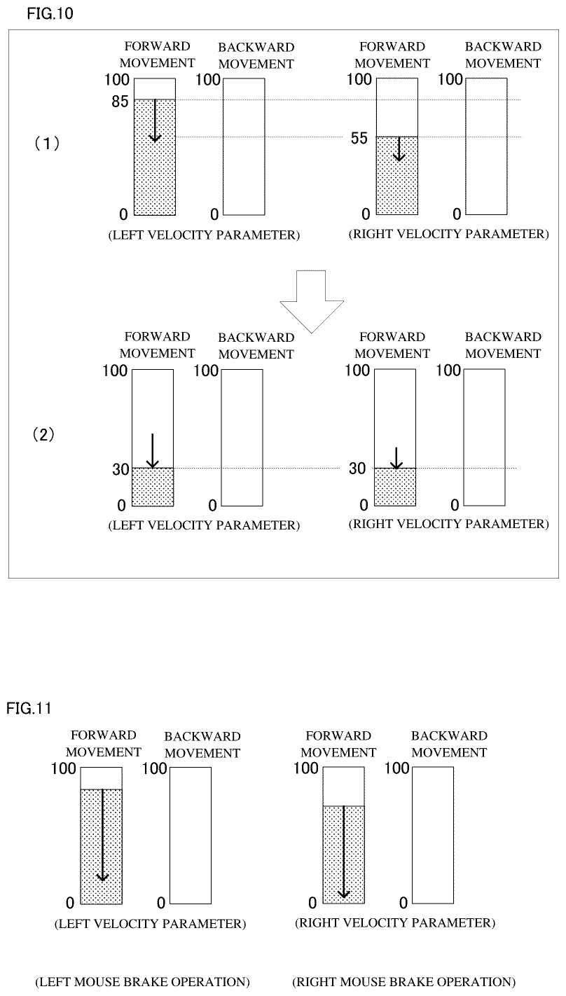

FIG. 10 illustrates control for decelerating the PO 100 that is moving (or rotating). In the game processing, in order to reproduce deceleration of a wheelchair due to resistance (frictional resistance, air resistance), subtraction (resistance subtraction) is gradually performed in accordance with passage of time on the movement speed of the PO 100. A specific description will be given below.

For example, the case where the value of “forward movement” of the LVP is 85, the value of “forward movement” of the RVP is 55, and the PO 100 is moving while making a right turn, is considered. In this case, as shown in FIG. 10(1), subtraction is performed on each of the value of “forward movement” of the LVP and the value of “forward movement” of the RVP. At this time, the value of “forward movement” of the RVP which is smaller is decreased at a subtraction speed serving as a reference (e.g., a subtraction speed of 20 per second; sometimes referred to as “reference subtraction speed”), and the value of “forward movement” of the LVP which is larger is decreased at a subtraction speed higher than the reference subtraction speed. As a result, the difference between the value of “forward movement” of the LVP and the value of “forward movement” of the RVP gradually decreases. Then, the values of the left and right VPs become equal at 30 in FIG. 10(2) and then are decreased at the reference subtraction speed. In the above, the resistance subtraction when the PO 100 is moving forward has been described. The resistance subtraction when the PO 100 is moving backward is the same.

In the above, during resistance subtraction, the value of the VP that is larger is brought closer to the value of the VP that is smaller. However, in another exemplary embodiment, the value of the VP that is smaller may be brought closer to the value of the VP that is larger, or both VP values may be brought closer to the average (intermediate value) thereof.

Next, acceleration or deceleration when the PO 100 is located on a ground object that is sloped (inclined) will be described. Since an actual wheelchair is influenced by the inclination of the ground, if the wheelchair is located on a slope, the wheelchair receives a force in a direction of descending the slope. For example, if an actual wheelchair faces in a direction of descending a slope, the wheelchair accelerates in the direction of descending the slope even without an operation of rotating the wheels being performed. In order to reproduce such influence of a ground inclination, gradient addition or gradient subtraction is performed on the LVP and the RVP at addition speeds or subtraction speeds corresponding to the gradients (inclinations) of the ground objects on the left wheel 101 side and the right wheel 102 side of the PO 100, respectively, in the game processing.

For example, when the PO 100 is located on a slope and is moving while facing in a direction of descending the slope, gradient addition is performed on the values of “forward movement” of the left and right VPs. For example, when the PO 100 is located on a slope and is moving while facing in a direction of ascending the slope, gradient subtraction is performed on the values of “forward movement” of the left and right VPs. In addition, there is a case where the VPs are switched from “forward movement” to “backward movement” as a result of gradient subtraction (i.e., the movement state of the PO 100 is switched from forward movement to backward movement due to the influence of a slope) and gradient addition is performed on the values of “backward movement” of the VPs. Similarly, there is a case where the VPs are switched from “backward movement” to “forward movement” as a result of gradient subtraction (i.e., the movement state of the PO 100 is switched from backward movement to forward movement due to the influence of a slope) and addition (gradient addition) is performed on the values of “forward movement” of the VPs.

Furthermore, the degrees of gradient addition and gradient subtraction (addition speed, subtraction speed) depend on, for example, the orientation of the PO 100 with respect to the direction of a slope and the magnitude of the gradient of the slope. Specifically, the closer the front direction of the PO 100 is to the direction of descending the slope, the greater the degree of gradient addition is, and the closer the front direction of the PO 100 is to the direction of ascending the slope, the greater the degree of gradient subtraction is. In addition, the steeper the slope is, the greater the degree of gradient addition or gradient subtraction is. An upper limit value (e.g., “70”) may be set for the value of the VP to be increased by gradient addition. Furthermore, this upper limit value may be switched and set in accordance with the magnitude of the gradient of the slope.

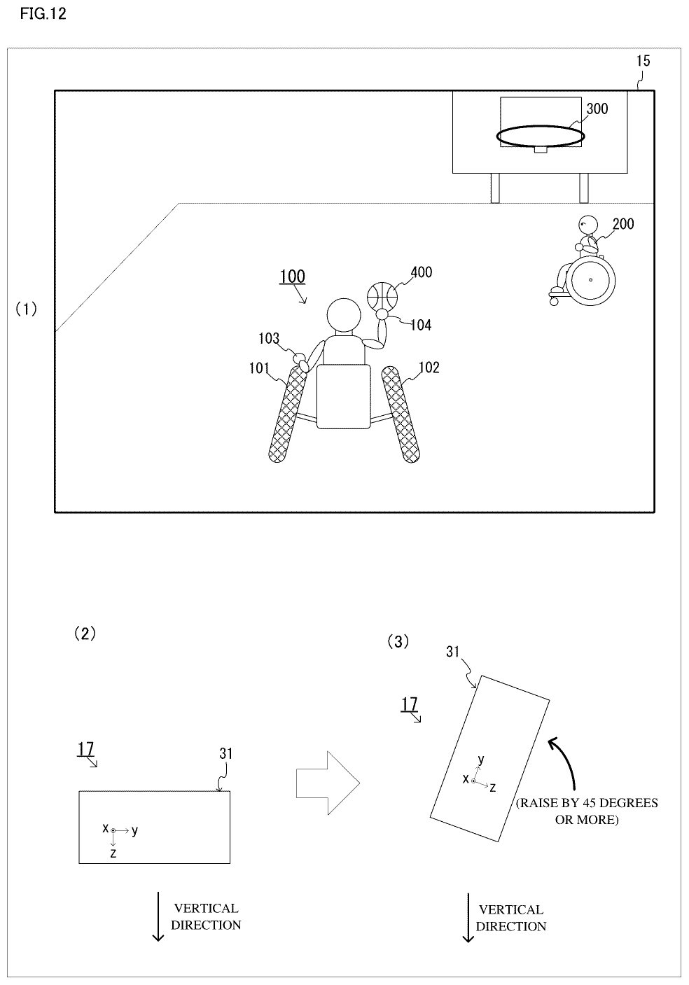

FIG. 11 illustrates the case where a brake operation is performed by the player. The player can apply the brake to the left wheel 101 side of the PO 100 by pressing the button 22 of the left mouse 16 and can apply the brake to the right wheel 102 side of the PO 100 by pressing the button 32 of the right mouse 17 (see FIG. 2 and FIG. 3).

Specifically, when the button 22 of the left mouse 16 is pressed, brake subtraction is performed on the value of the LVP at a predetermined subtraction speed (e.g., a subtraction speed of 100 per second; sometimes referred to as “brake subtraction speed”), and when the button 32 of the right mouse 17 is pressed, brake subtraction is performed on the value of the RVP at the brake subtraction speed. The brake subtraction speed is higher than the subtraction speed by the resistance subtraction described above. In FIG. 11, the button 22 and the button 32 are pressed, the left and right VPs are decreased at the brake subtraction speed, and as a result, the PO 100 rapidly decelerates.

In the game processing (see FIGS. 5(1) and (2), etc.), as an example, an animation in which the left wheel 101 rotates at a rotation speed and in a rotation direction indicated by the LVP is displayed, and an animation in which the right wheel 102 rotates at a rotation speed and in a rotation direction indicated by the RVP is displayed.

In addition, in the game processing (see FIG. 5(1), etc.), as an example, if the left mouse movement operation is performed in the forward direction or the backward direction, a left hand 103 of the PO 100 grasps the left wheel 101 and moves the left wheel 101 in a direction corresponding to the left mouse movement operation, and if the right mouse movement operation is performed in the forward direction or the backward direction, a right hand 104 of the PO 100 grasps the right wheel 102 and moves the right wheel 102 in a direction corresponding to the right mouse movement operation.

Furthermore, in the game processing, as an example, the left mouse 16 is vibrated at time intervals corresponding to the rotation speed of the left wheel 101 (movement speed on the left side), and the right mouse 17 is vibrated at time intervals corresponding to the rotation speed of the right wheel 102 (movement speed on the right side). For example, each mouse may be vibrated at shorter time intervals as the rotation speed of the wheel is higher. This allows the user to intuitively recognize the movement speed of the PO 100. When either wheel is separated from the ground due to jumping or traveling on a single wheel, the mouse corresponding to this wheel may not necessarily be vibrated. In addition, the left and right mice may be vibrated depending on the movement distance of the PO 100 itself (e.g., regardless of the movement speeds on the left side and the right side). Furthermore, at least one of the left and right mice may be vibrated based on the movement amount of at least one of the left and right mice. As described above, at least one of the left and right mice may be vibrated based on at least one of data acquired by the left and right mouse sensors. Moreover, the mice may be vibrated based on the conditions of the ground on which the PO 100 is located (e.g., gravel, sand, soil, concrete, etc.). The mice may be vibrated based on a combination of the factors described above for vibrating the mice (the rotation speeds of the wheels, the movement distance of the PO 100 itself, the movement amount of the mouse, the conditions of the ground).

Furthermore, in the game processing, the mice are vibrated when the PO 100 collides with another PO. Specifically, the left mouse 16 is vibrated when the left wheel 101 side of the PO 100 collides with another PO, and the right mouse 17 is vibrated when the right wheel 102 side of the PO 100 collides with another PO. When the front or back surface of the PO 100 collides with another PO, the left and right mice 16 and 17 may be vibrated simultaneously.

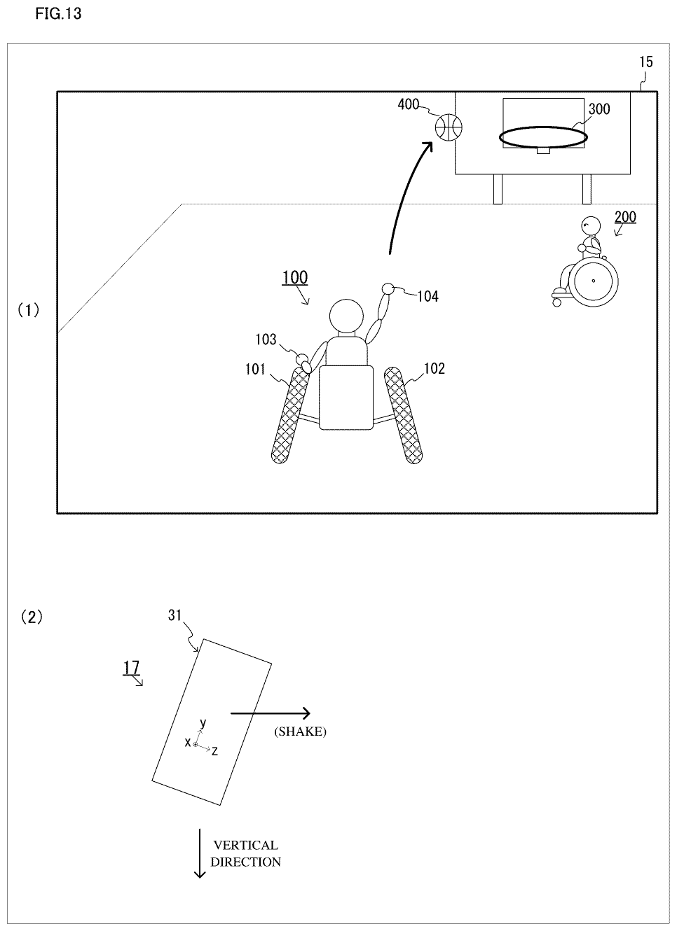

FIG. 12 illustrates an operation for causing the PO 100 to assume a posture for shooting (sometimes referred to as “shooting posture”). The player can cause the PO 100 to assume a shooting posture by performing an operation of raising at least one of the left mouse 16 and the right mouse 17.

Specifically, if the right mouse 17 is brought into a state where the right mouse 17 has been raised (sometimes referred to as “shooting posture operation state”) in a state where the PO 100 holds the ball 400, the PO 100 assumes a shooting posture in which the ball 400 is lifted with the right hand 104 (see FIG. 12(1)). Similarly, when the left mouse 16 is brought into the shooting posture operation state in a state where the PO 100 holds the ball 400, the PO 100 assumes a shooting posture in which the ball 400 is lifted with the left hand 103 (not shown). In addition, when one mouse is in the shooting posture operation state, if the other mouse is brought into the shooting posture operation state (or if both mice are brought into the shooting posture operation state simultaneously), the PO 100 assumes a shooting posture in which the ball 400 is lifted with both hands (103 and 104) (not shown). The method for determining whether the mouse has been raised is not particularly limited. As an example, it may be determined using the inertial sensor that the z-axis positive direction is changed from a state of being directed in a direction less than 45 degrees relative to the vertical direction (see FIG. 2, FIG. 12(2)) to a state of being directed in a direction of 45 degrees relative to the vertical direction (see FIG. 12(3)). Alternatively, this determination may be made based on the movement or the movement direction of the mouse, detection that the mouse has become separated from the work surface, etc.

While at least one mouse is in the shooting posture operation state, the PO 100 maintains a shooting posture. When both mice are no longer in the shooting posture operation state, the PO 100 ends the shooting posture. Even if the PO 100 does not hold the ball 400, in response to a mouse being brought into the shooting posture operation state, the PO 100 performs a motion of raising the hand corresponding to the mouse that has been brought into the shooting posture operation state.

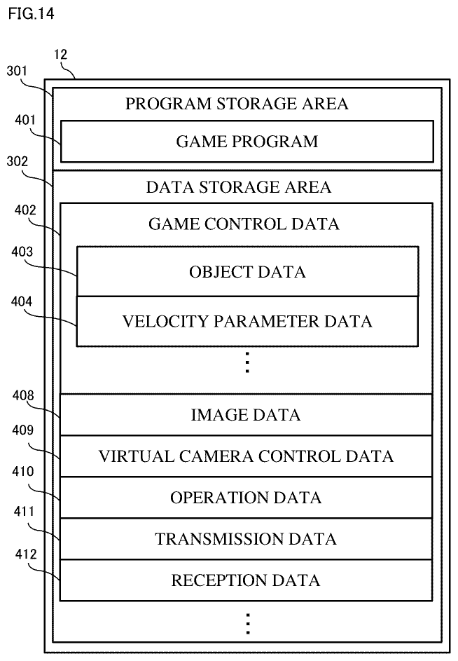

FIG. 13 illustrates an operation for causing the PO 100 to shoot (operation for causing the PO 100 to perform a shooting action). By performing an operation of shaking a mouse that has been brought into the shooting posture operation state, the player can cause the PO 100 to perform a shooting action and always shoot toward the goal 300 on the opponent side.

Specifically, as shown in FIG. 13(2), when the PO 100 assumes a shooting posture with its right hand raised, if the right mouse 17 that has been brought into the shooting posture operation state is shaken, the PO 100 performs a shooting action by throwing the ball 400 toward the goal 300 with its right hand 104 (see FIG. 13(1)). Similarly, when the PO 100 assumes a shooting posture with its left hand, if the left mouse 16 that has been brought into the shooting posture operation state is shaken, the PO 100 shoots by throwing the ball 400 toward the goal 300 with the left hand 103 (not shown). In addition, when the PO 100 assumes a shooting posture with both hands, if at least one of the left mouse 16 and the right mouse 17 that have been brought into the shooting posture operation state is shaken, the PO 100 shoots by throwing the ball 400 toward the goal 300 with both hands (not shown). The method for determining whether the mouse has been shaken is not limited. As an example, whether the mouse has been shaken may be determined based on detection of a predetermined amount or more of change in acceleration in the z-axis positive direction or may be determined based on movement or rotation in another direction.

The shot ball 400 generally flies toward the goal 300 regardless of the orientation of the PO 100. Then, whether or not the shot ball 400 enters the goal 300 is based on a probability (sometimes referred to as “shot success rate”). The shot success rate depends on the orientation of the PO 100 at the time when the PO 100 shoots, for example. Specifically, the closer the front direction of the PO 100 at the time of the shot is to the direction toward the goal 300, the higher the shot success rate is. The shot success rate may be set to be higher when the PO 100 shoots with both hands than when the PO 100 shoots with one hand. Moreover, the shot success rate may be set to be higher when the PO 100 shoots at a position closer to the goal 300.

In the game processing, when the PO 100 holds the ball 400, if the PO 100 collides with another PO, the PO 100 drops the ball 400. In addition, if the PO 100 enters a predetermined range of the ball 400 that has fallen or is moving due to a pass, the PO 100 holds the ball 400. Moreover, in response to a predetermined operation on the mouse, the PO 100 passes the held ball 400 to the closet teammate PO.

### Details of Information Processing of Exemplary Embodiment

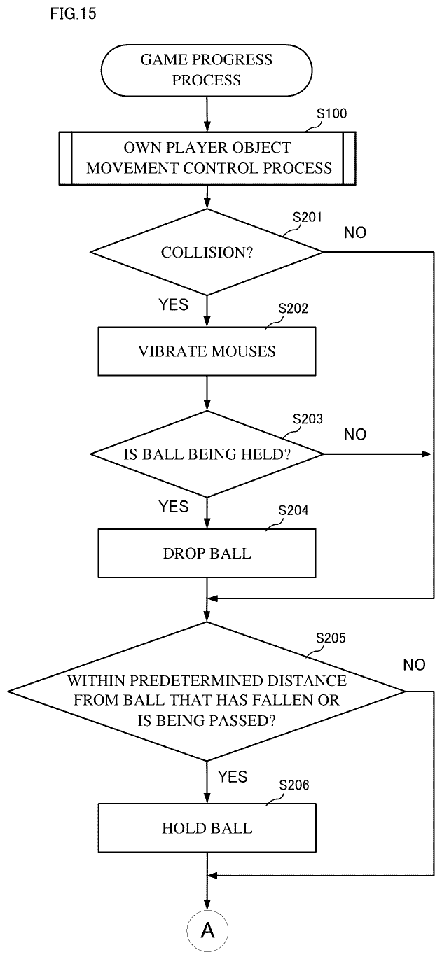

Next, the information processing of the exemplary embodiment will be described in detail with reference to FIG. 14 to FIG. 18.

### [Data to be Used]

Various data to be used in the game processing will be described. FIG. 14 shows an example of data stored in the storage unit 12 of the game apparatus 10. As shown in FIG. 14, the storage unit 12 is provided with at least a program storage area 301 and a data storage area 302. A game program 401 is stored in the program storage area 301. In the data storage area 302, game control data 402, image data 408, virtual camera control data 409, operation data 410, transmission data 411, reception data 412, etc., are stored. The game control data 402 includes object data 403 and velocity parameter (VP) data 404.

The game program 401 is a game program for executing the game processing.

The object data 403 is data of objects to be placed in the virtual space and is data of POs (own PO 100, other PO 200, etc.) and objects such as the ground (court), a ball, and a goal. The object data 403 also includes data of the coordinates (position), orientation, posture, state, etc., of each object.

The velocity parameter (VP) data 404 is data described with reference to FIG. 4(2), FIG. 5(2), etc.

The image data 408 is image data of animation images in which the wheels of the PO 100 rotate, background, virtual effects, etc.

The virtual camera control data 409 is data for controlling the movement of a virtual camera to be placed in the virtual space.

The operation data 410 is data indicating the contents of operations performed on the left mouse 16 and the right mouse 17. The operation data 410 includes, for example, data indicating the movements (including movements on the work surfaces) and posture changes of the left mouse 16 and the right mouse 17 and input states for pressed states of various buttons, etc. The contents of the operation data are updated at a predetermined cycle, based on signals from the left mouse 16 and the right mouse 17.

The transmission data 411 is data to be transmitted to other game apparatuses 10 and is data including at least information for identifying the transmission source and the contents of the operation data 410. The transmission data 411 includes data (data indicating coordinates (position), posture, state, etc.) regarding the own PO 100 to be transmitted to the game apparatuses 10 of other multi-play players (or a server).

The reception data 412 is data that is transmission data received from the other game apparatuses 10 and stored so as to be identifiable for each of the other game apparatuses 10 (that is, such that the transmission source can be identified). The reception data 412 includes data (data indicating coordinates (position), posture, state, etc.) regarding other POs received from the game apparatuses 10 of the other multi-play players (or the server).

In addition, various data to be used in the game processing and rendering processing are stored in the storage unit 12 as necessary.

### [Details of Game Processing]

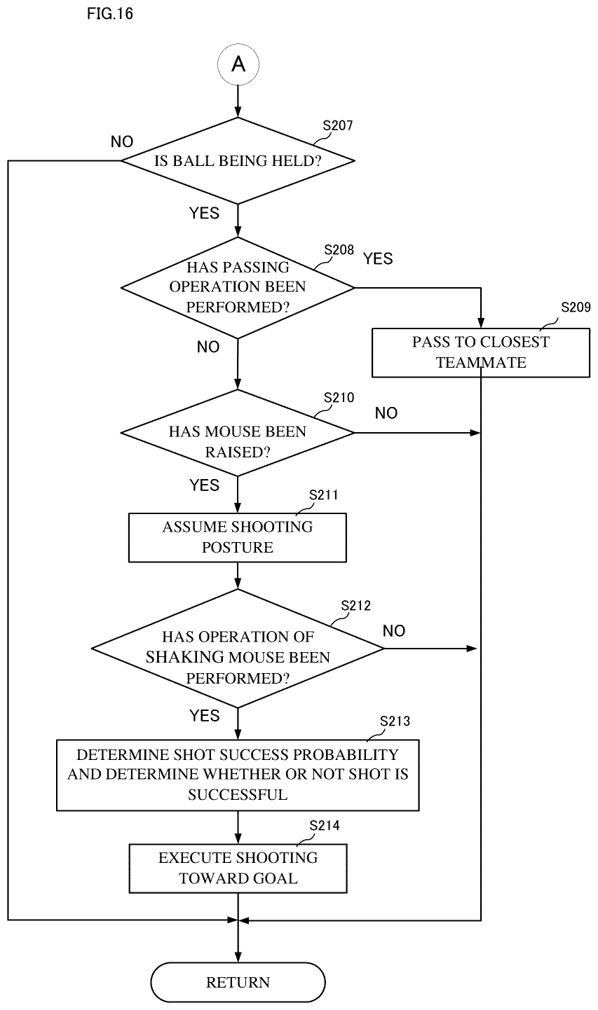

Next, the game processing according to the exemplary embodiment will be described with reference to flowcharts. FIG. 15 to FIG. 18 are examples of flowcharts showing the game processing according to the exemplary embodiment. Hereinafter, processing characteristic of the exemplary embodiment will be described, and the description for other processing is omitted. For example, the description of processing of reflecting the reception data 412, rendering processing, processing of transmitting the transmission data, etc., is omitted.

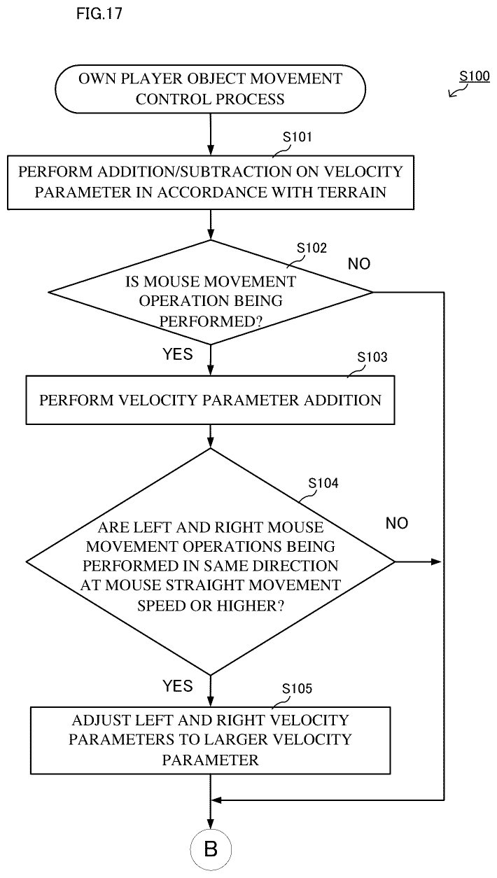

When the game processing is started and a match in the wheelchair basketball game is started, a game progress process in FIG. 15 and FIG. 16 is started. This process is executed at predetermined intervals (e.g., every rendering frame). When the match in the wheelchair basketball game ends, the game processing ends.

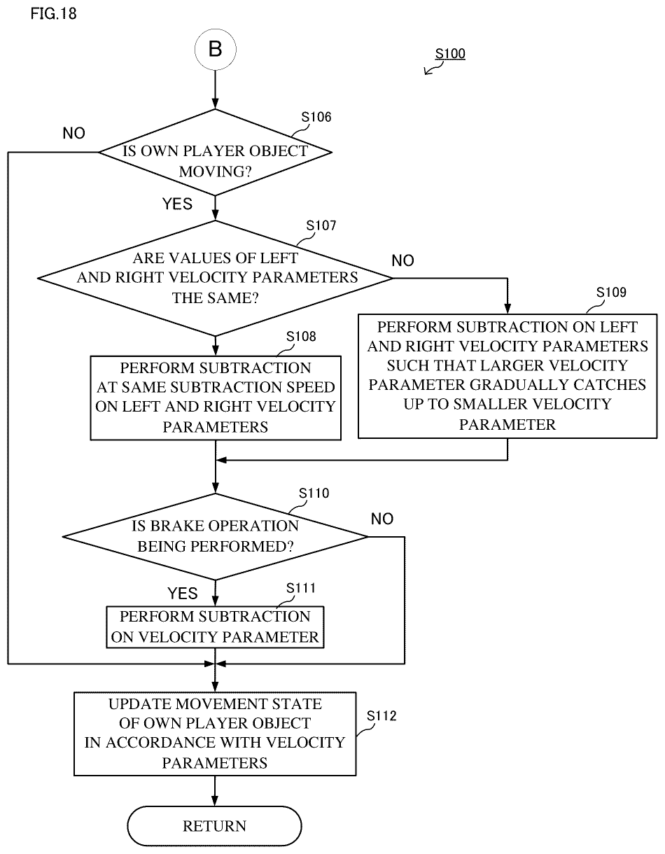

First, in step S100 in FIG. 15, the processor 11 performs an own PO movement control process. The own PO movement control process is a process of moving the PO 100 based on operations of the player, for example. The own PO movement control process will be described below with reference to FIG. 17 and FIG. 18.

First, in step S101 in FIG. 17, the processor 11 performs gradient addition or gradient subtraction on the left and right VPs in accordance with the gradient of the terrain on which the PO 100 is located, as described above, based on the object data 403. Then, the processing proceeds to step S102.

In step S102, the processor 11 determines whether or not the mouse movement operation is being performed on at least one of the left and right mice, based on the operation data 410. If the result of the determination in step S102 is YES, the processing proceeds to step S103, and if the result of this determination is NO, the processing proceeds to step S106 in FIG. 18.

In step S103, the processor 11 performs addition on the VP corresponding to the mouse on which it is determined in step S102 that the mouse movement operation is being performed, based on the operation data 410. Specifically, the processor 11 performs mouse operation addition on at least one of the left and right VPs in accordance with the mouse movement operation as described with reference to FIG. 4 to FIG. 8, etc. Then, the processing proceeds to step S104.

In step S104, the processor 11 determines whether or not the left and right mouse movement operations are being performed in the same direction at the mouse straight movement speed or higher as described with reference to FIG. 9, based on the operation data 410. If the result of the determination in step S104 is YES, the processing proceeds to step S105, and if the result of this determination is NO, the processing proceeds to step S106 in FIG. 18.

In step S105, the processor 11 adjusts the values of the left and right VPs to be the same as the larger value as described with reference to FIG. 9. Then, the processing proceeds to step S106 in FIG. 18.

In step S106 in FIG. 18, the processor 11 determines whether or not the PO 100 is moving, based on the object data 403. If the result of the determination in step S106 is YES, the processing proceeds to step S107, and if the result of this determination is NO, the processing proceeds to step S112.

In step S107, the processor 11 determines whether or not the values of the left and right VPs are the same, based on the VP data 404. If the result of the determination in step S107 is YES, the processing proceeds to step S108, and if the result of this determination is NO, the processing proceeds to step S109.

In step S108, the processor 11 performs subtraction (resistance subtraction) at the same subtraction speed (reference subtraction speed) on the left and right VPs as described with reference to FIG. 10. Then, the processing proceeds to step S110.

In step S109, the processor 11 performs subtraction (resistance subtraction) on the left and right VPs such that the value of the VP that is larger gradually catches up to the value of the VP that is smaller as described with reference to FIG. 10. Then, the processing proceeds to step S110.

In step S110, the processor 11 determines whether or not a brake operation is being performed, based on the operation data 410. Specifically, the processor 11 determines whether or not at least one of the button 22 of the left mouse 16 and the button 32 of the right mouse 17 is being pressed as described with reference to FIG. 11. If the result of the determination in step S110 is YES, the processing proceeds to step S111, and if the result of this determination is NO, the processing proceeds to step S112.

In step S111, the processor 11 performs subtraction on the VP. Specifically, the processor 11 performs subtraction (brake subtraction) at the brake subtraction speed on the value of the VP corresponding to the mouse in which it is determined in step S110 that the button is being pressed, as described with reference to FIG. 11. Then, the processing proceeds to step S112.

In step S112, the processor 11 updates the movement state of the PO 100 in accordance with the VPs calculated by the process from step S101 to step S111 (process of performing addition/subtraction on the LVP and the RVP). Specifically, the processor 11 determines a movement direction (including a turning direction) and a movement speed based on the calculated values of the LVP and the RVP and moves the own PO 100. Then, the processing proceeds to step S201 in FIG. 15.

In step S201 in FIG. 15, the processor 11 determines whether or not the PO 100 has collided with another PO, based on the object data 403. If the result of the determination in step S201 is YES, the processing proceeds to step S202, and if the result of this determination is NO, the processing proceeds to step S205.

In step S202, the processor 11 vibrates each mouse using the vibration device provided in the mouse. Then, the processing proceeds to step S203.

In step S203, the processor 11 determines whether or not the PO 100 is holding the ball, based on the object data 403. If the result of the determination in step S203 is YES, the processing proceeds to step S204, and if the result of this determination is NO, the processing proceeds to step S205.

In step S204, the processor 11 causes the PO 100 to drop the held ball. Then, the processing proceeds to step S205.

In step S205, the processor 11 determines whether or not the PO 100 is located within a predetermined distance from the ball that has fallen or is being passed, based on the object data 403. If the result of the determination in step S205 is YES, the processing proceeds to step S206, and if the result of this determination is NO, the processing proceeds to step S207 in FIG. 16.

In step S206, the processor 11 causes the PO 100 to hold the ball that has fallen or is being passed. Then, the processing proceeds to step S207 in FIG. 16.

In step S207 in FIG. 16, the processor 11 determines whether or not the PO 100 is holding the ball, based on the object data 403. If the result of the determination in step S207 is YES, the processing proceeds to step S208, and if the result of this determination is NO, the processing returns to step S100 in FIG. 15.

In step S208, the processor 11 determines whether or not an operation for passing has been performed, based on the operation data 410. If the result of the determination in step S208 is YES, the processing proceeds to step S209, and if the result of this determination is NO, the processing proceeds to step S210.

In step S209, the processor 11 causes the PO 100 to pass toward the teammate PO closest to the PO 100, based on the object data 403. Then, the processing returns to step S100 in FIG. 15.

In step S210, the processor 11 determines whether or not either mouse has been raised, based on the operation data 410. Specifically, the processor 11 determines whether or not at least one of the left mouse 16 and the right mouse 17 is in the shooting posture operation state as described with reference to FIG. 12. If the result of the determination in step S210 is YES, the processing proceeds to step S211, and if the result of this determination is NO, the processing returns to step S100 in FIG. 15.

In step S211, the processor 11 causes the PO 100 to assume a shooting posture (or maintain a shooting posture) as described with reference to FIG. 12. Then, the processing proceeds to step S212. If the shooting posture operation state ends, the PO 100 ends the shooting posture.

In step S212, the processor 11 determines whether or not an operation of shaking either mouse (operation for shooting) has been performed as described with reference to FIG. 13, based on the operation data 410. If the result of the determination in step S212 is YES, the processing proceeds to step S205, and if the result of this determination is NO, the processing returns to step S100 in FIG. 15.

In step S213, the processor 11 determines a shot success probability as described with reference to FIG. 13, based on the object data 403, and determines whether a shot is successful by performing random selection with the determined shot success probability. Then, the processing process proceeds to step S214.

In step S214, the processor 11 causes the PO 100 to shoot toward the goal 300 regardless of the orientation of the PO 100. Then, the processing returns to step S100 in FIG. 15. In another control flow (not shown), the following process is executed: the ball shot by the process in step S214 moves toward the goal 300, and if the shot is determined to be successful in step S213, the ball enters the goal 300 to score points for the own team, or if the shot is determined not to be successful in step S213, the ball does enter the goal 300 and the shot fails.

According to the exemplary embodiment described above, as described with reference to FIG. 4 to FIG. 9, etc., the player can play the game by performing operations of moving the left and right mice on the work surfaces to operate the left and right wheels of the PO 100 as if the wheels were the wheels of an actual wheelchair.

Furthermore, according to the exemplary embodiment, as described with reference to FIG. 9, if the left and right mouse movement operations are performed at the mouse straight movement speed or higher, adjustment is performed such that the values of the left and right VPs are constantly made to be the same. This enables assistance in performing an operation for causing the PO 100 to start moving straight (or accelerate straight).

Furthermore, according to the exemplary embodiment, as described with reference to FIG. 10, when resistance subtraction is performed on the movement speed of the PO 100 (VPs), subtraction is performed while bringing the value of the LVP and the value of the RVP closer to each other. This enables assisting the PO 100 in moving straight.

Furthermore, according to the exemplary embodiment, gradient addition or gradient subtraction is performed on the movement speed of the PO 100 (VPs) based on the gradient of the ground (court). This enables reproduction of the movement of an actual wheelchair, which accelerates or decelerates due to a gradient.

Furthermore, according to the exemplary embodiment, as described with reference to FIG. 12 and FIG. 13, by performing an operation of raising the mouse and then shaking the mouse, the PO 100 can be caused to assume a shooting posture and then shoot. This can provide an operation sense similar to the actual motion of shooting. Moreover, an operation for causing the PO 100 to accurately aim at the goal while moving forward or backward or turning using both mice may become excessively difficult, but by determining the success or failure of a shot based on a probability corresponding to the orientation with respect to the goal, it is possible to provide a game having an appropriate difficulty level. In the exemplary embodiment, since the shot ball flies toward the goal, a situation in which the ball flies in a direction totally different from the goal, thereby causing the user to immediately understand that the ball will not enter the goal and reducing the entertainment characteristics, is avoided.

### Modifications

In the exemplary embodiment described above, the wheelchair basketball game has been described as an example, but the game is not limited thereto and may be, for example, a game in which a boat is moved, etc. For example, in the case of a game in which a PO 100 riding on a boat, which moves with left and right oars, so as to face in a direction opposite to the forward direction of the boat, rows the left oar with the left hand and rows the right oar with the right hand, the tips of the left and right oars push water from the front to the back to cause the boat to move forward, by the left and right mice being moved from the far side to the near side (in the y-axis negative direction in FIG. 2(1)).

In the exemplary embodiment described above, after the left and right VPs are calculated, the movement speed or direction of the PO 100 as a whole is calculated based on the calculated left and right VPs, and the movement of the PO 100 is controlled based on the calculated movement speed or direction, but the method for controlling the movement of the PO 100 is not limited thereto. For example, the left wheel may be actually rotated in accordance with the LVP to perform movement control, and the right wheel may be actually rotated in accordance with the RVP to perform movement control (i.e., physical calculation processing may be performed), thereby controlling the movement of the PO 100.

In the exemplary embodiment described above, the VPs are calculated and used for various types of control, but the parameters used for various types of control are not limited to the VPs, and appropriate parameters may be calculated and appropriate control may be executed.

In the exemplary embodiment described above, as described with reference to FIG. 13, the shot success rate is determined based on the orientation of the PO 100 at the time of a shot, but the present disclosure is not limited thereto. For example, the movement of the shot ball may be controlled by physical calculation processing, and if the ball enters the goal as a result, the shot may be considered to be successful.

In the exemplary embodiment described above, the target of a pass is the teammate PO closest to the PO 100 but may be another teammate. For example, a pass may be made to the closest teammate in the front direction of the PO 100. The movement speed or direction of the PO 100 and the movement speed or direction of each teammate may be taken into consideration for the selection of the target of a pass. In addition, the user may select a pass target using various buttons.

In the exemplary embodiment described above, as described with reference to FIG. 9 and FIG. 10, adjustment is performed such that the values of the left and right VPs are brought closer to each other, but this adjustment may not necessarily be performed.

In the exemplary embodiment described above (see FIG. 2), each mouse sensor (20, 30) detects the movement of the mouse (16, 17) on the work surface and outputs the movement direction, the movement amount, etc., of the mouse (16, 17). In another exemplary embodiment, each mouse sensor may output only data regarding reflected light from the work surface, and the game apparatus 10 may calculate whether the mouse has moved on the work surface, and the movement direction, the movement amount, etc., of the mouse, based on the data. In addition, the game apparatus 10 or the mouse may calculate the current position of the mouse in a mouse coordinate system, and various types of processing may be executed based on the calculated current position. The same applies to the inertial sensor provided in each mouse, and the actual posture, etc., may be calculated by either the game apparatus 10 or the mouse.

In the exemplary embodiment described above, each VP is calculated based on the movement speed of the mouse in the y-axis direction, but the movement speed of the mouse in the x-axis direction may be used to calculate the VP. As an example, each VP may be calculated based on the movement speed of the mouse on the xy plane.

In the exemplary embodiment described above, the shapes of the left mouse 16 and the right mouse 17 (see FIG. 2) are examples. For example, the shapes of the left mouse 16 and the right mouse 17 may be the same. Furthermore, for example, each mouse may include a grip that is easy for the user to hold and lift. As an example, the left mouse 16 and the right mouse 17 may be capable of being used like a general game controller. That is, a game controller having a mouse sensor (20, 30) is included in the scope of the mouse in the present disclosure. Moreover, the left mouse 16 and the right mouse 17 may be attachable to and detachable from other devices. In another exemplary embodiment, each mouse may include, on its surface, a ball that can be rotationally operated. In this case, instead of or in addition to the operation of movement on the work surface, the mouse may output substantially the same data as that when the mouse is moved on the work surface, by rotating the ball as desired. Game processing may be executed based on such data acquired from the two mice.

In the exemplary embodiment, a case in which a series of processes regarding the game processing are executed in the single game apparatus 10 has been described. In another exemplary embodiment, the series of processes may be executed in an information processing system including a plurality of information processing apparatuses. For example, in an information processing system including a terminal-side apparatus and a server-side apparatus communicable with the terminal-side apparatus via a network, some of the series of processes above may be executed by the server-side apparatus. Further, in an information processing system including a terminal-side apparatus and a server-side apparatus communicable with the terminal-side apparatus via a network, major processes among the series of processes above may be executed by the server-side apparatus, and some of the processes may be executed in the terminal-side apparatus. Further, in the above information processing system, the system on the server side may be implemented by a plurality of information processing apparatuses, and processes that should be executed on the server side may be shared and executed by a plurality of information processing apparatuses. Further, a configuration of so-called cloud gaming may be adopted. For example, a configuration may be adopted in which: the game apparatus 10 sends operation data indicating operations performed by the user to a predetermined server; various game processes are executed in the server; and the execution result is streaming-distributed as a moving image/sound to the game apparatus 10.

While the exemplary embodiment and the modifications have been described, the description thereof is in all aspects illustrative and not restrictive. It is to be understood that various other modifications and variations may be made to the exemplary embodiment and the modifications.

What is claimed is:

1. A non-transitory computer-readable storage medium having stored therein a game program comprising instructions that, when executed, cause a computer to perform operations comprising:
acquiring first data regarding movement, on a work surface, of a first mouse operated by one hand of a user;
acquiring second data regarding movement, on a work surface that is the same as or different from the work surface, of a second mouse operated by another hand of the user;
causing a first virtual object to move forward in a virtual space when the acquired first data and second data respectively indicate that the first mouse and the second mouse have been moved in a first direction;
causing the first virtual object to move backward when the acquired first data and second data respectively indicate that the first mouse and the second mouse have been moved in a direction opposite to the first direction; and
causing the first virtual object to turn left or right, based on a difference between a movement amount of the first mouse indicated by the first data and a movement amount of the second mouse indicated by the second data.

2. The storage medium according to claim 1, wherein the operations further comprise:
determining a first parameter increasing as the movement amount of the first mouse increases, based on the first data;
determining a second parameter increasing as the movement amount of the second mouse increases, based on the second data; and
adjusting at least one of values of the first parameter and the second parameter such that a difference between the first parameter and the second parameter decreases.

3. The storage medium according to claim 2, wherein the adjusting is adjustment in which, of the first parameter and the second parameter, the value of the parameter that is smaller is brought closer to the value of the parameter that is larger.

4. The storage medium according to claim 2, wherein the operations further comprise performing the adjusting when a movement speed of the first mouse indicated by the first data and a movement speed of the second mouse indicated by the second data are both higher than a predetermined value.

5. The storage medium according to claim 2, wherein the operations further comprise:
decreasing the first parameter in accordance with passage of time;
decreasing the second parameter in accordance with passage of time; and
decreasing the first parameter and the second parameter such that the difference between the first parameter and the second parameter decreases.

6. The storage medium according to claim 2, wherein the operations further comprise:
placing the first virtual object on a ground object in the virtual space; and
applying an influence corresponding to a state of the ground object at a position at which the first virtual object is placed, to the first parameter and the second parameter.

7. The storage medium according to claim 2, wherein the operations further comprise:
acquiring third data outputted in response to a first operation on the first mouse by the user;
acquiring fourth data outputted in response to the first operation on the second mouse by the user;
decreasing the first parameter, based on the acquired third data; and
decreasing the second parameter, based on the acquired fourth data.

8. The storage medium according to claim 1, wherein the operations further comprise causing the first virtual object to perform a shooting action of causing a second virtual object to fly from the first virtual object in the virtual space, based on fifth data, acquired from at least one of the first mouse and the second mouse, indicating an operation of raising the mouse and then shaking the mouse.

9. The storage medium according to claim 8, wherein the operations further comprise:
causing the second virtual object to fly toward a goal, in response to the shooting action, regardless of orientation of the first virtual object; and
determining a probability of success of a shot by the shooting action, based on orientation of the first virtual object with respect to the goal at a time of the shooting action.

10. The storage medium according to claim 1, wherein
the first virtual object is a wheelchair object, and
the operations further comprise vibrating at least one of the first mouse and the second mouse, based on at least one of the first data and the second data.

11. A game processing method executed by a computer, the game processing method causing the computer to perform operations comprising:
acquiring first data regarding movement, on a work surface, of a first mouse operated by one hand of a user;
acquiring second data regarding movement, on a work surface that is the same as or different from the work surface, of a second mouse operated by another hand of the user;
causing a first virtual object to move forward in a virtual space when the acquired first data and second data respectively indicate that the first mouse and the second mouse have been moved in a first direction;
causing the first virtual object to move backward when the acquired first data and second data respectively indicate that the first mouse and the second mouse have been moved in a direction opposite to the first direction; and
causing the first virtual object to turn left or right, based on a difference between a movement amount of the first mouse indicated by the first data and a movement amount of the second mouse indicated by the second data.

12. The game processing method according to claim 11, wherein the operations further comprise:
determining a first parameter increasing as the movement amount of the first mouse increases, based on the first data;
determining a second parameter increasing as the movement amount of the second mouse increases, based on the second data; and
adjusting at least one of values of the first parameter and the second parameter such that a difference between the first parameter and the second parameter decreases.

13. A system comprising a first mouse, a second mouse, and a game apparatus,
the first mouse being configured to transmit first data regarding movement, on a work surface, of the first mouse,
the second mouse being configured to transmit second data regarding movement, on a work surface, of the second mouse,
the game apparatus being configured to receive the first data and the second data,
the game apparatus being configured to execute a game program,
the game program causing the game apparatus to:
cause a first virtual object to move forward in a virtual space when the received first data and second data respectively indicate that the first mouse and the second mouse have been moved in a first direction;
cause the first virtual object to move backward when the received first data and second data respectively indicate that the first mouse and the second mouse have been moved in a direction opposite to the first direction; and
cause the first virtual object to turn left or right, based on a difference between a movement amount of the first mouse indicated by the first data and a movement amount of the second mouse indicated by the second data.

14. The system according to claim 13, wherein
the first mouse has a plate shape in which a side surface extending in a longitudinal direction of the plate shape is a bottom surface facing the work surface when the first mouse is operated to be moved on the work surface, and
the second mouse has a plate shape in which a side surface extending in a longitudinal direction of the plate shape is a bottom surface facing the work surface when the second mouse is operated to be moved on the work surface.

15. The system according to claim 13, wherein
the first mouse and the second mouse each include a vibration device, and
the game program causes the game apparatus to function as means for vibrating at least one of the first mouse and the second mouse, based on at least one of the received first data and second data.
